(19) United States
(12) Patent Application Publication
(10) Pub. No.: US 2026/0299966 A1
(43) Pub. Date: Oct. 1, 2026

(54) Multi-Tool Extension for Software

(71) Applicant: The Travelers Indemnity Company, Hartford, CT (US)

(72) Inventors: Douglas L. Roy, Plantsville, CT (US); David M. Rollins, West Hartford, CT (US)

(21) Appl. No.: 19/095,397

(22) Filed: Mar. 31, 2025

(51) Int. Cl. G06F 9/445; G06F 8/65

(52) U.S. Cl. CPC G06F 9/44526; G06F 8/65

(57) ABSTRACT

Techniques for software extensions and plugin tools are disclosed. A computing system executes a multi-tool extension in an extensible software environment of a user. Via the extensible software environment, the system uses the multi-tool extension to install a plugin tool from a restricted plugin tool library. The plugin tool in the plugin tool library is authorized to access the computing asset. The plugin tool receives a request from the user for the restricted computing asset. The plugin tool calls that restricted asset via the multi-tool extension. In response to the call, the extensible software environment presents information obtained from the restricted computing asset.

### BACKGROUND

Various types of software can host extensions and plugins that enhance the software's native functionality. Extensions typically augment existing features of the host software. For instance, an ad blocker extension enhances a web browser by preventing advertisements from appearing on web pages. Plugins typically add new functionality to the host software. For example, an artificial intelligence (AI) chat plugin may be installed in a code editor to interpret spoken language using a large language model (LLM) to assist coding capabilities of the editor.

The approaches described in this section are ones that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example architecture of a computing environment of a multi-tool platform in accordance with one or more embodiments;

FIG. 2 illustrates an example architecture of a multi-tool tool platform in accordance with one or more embodiments;

FIG. 3 illustrates an example set of operations for publishing plugin tools in accordance with one or more embodiments;

FIGS. 4A and 4B illustrate an example set of operations for installing plugin tools in accordance with one or more embodiments;

FIG. 5 illustrates an example of installing plugin tool bundles for users in accordance with one or more embodiments;

FIG. 6 illustrates an example set of accessing computing resources using plugin tools in accordance with one or more embodiments;

FIGS. 7 and 8 illustrate example user interface screens in accordance with one or more embodiments; and

FIG. 9 illustrates an example of a data structure storing plugin tool metadata in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram to avoid unnecessarily obscuring the present disclosure.

### 1. General Overview

Aspects of the present disclosure relate to software extensions and plugins. Embodiments execute a software extension having access to computing assets within a controlled computing environment of an organization. The software extension, referred to herein as a “multi-tool extension,” supports the installation of multiple plugin tools in software of a user. Via the multi-tool extension, the software installs one or more plugin tools generated for the controlled computing environment. Responsive to a user making a request to an installed plugin tool, the plugin tool interacts with the multi-tool extension to securely access the computing assets of the controlled computing environment, responds to the request, and presents the response within a user interface of the software.

One or more embodiments described in this Specification and/or recited in the claims may not be included in this General Overview section.

### 2. Practical Applications, Advantages & Improvements

Systems and methods in accordance with aspects of the present disclosure improve the functioning of computing systems by enhancing the flexibility, customizability, and security of extensible software. Embodiments install the multi-tool extension into applications to manage and interface with plugin tools tailored for accessing resources (e.g., databases, services, and application program interfaces (APIs)) of a controlled computing environment. For example, the multi-tool extension may install a custom LLM chatbot plugin that is optimized for the contexts, vocabularies, and information sources of a particular organization.

Embodiments of the multi-tool extension interact with a plugin tool platform to identify, install, manage, and activate plugin tools entirely within the user interface of an application. The multi-tool extension enables users to manage plugin tools entirely within the user interface of the application. Doing so improves the security, usability, and efficiency of the computing system by avoiding users navigating outside an active application to an untrusted source to obtain plugin tools.

Additionally, embodiments implement plugin tools that include multiple functions rather than single function extensions or plugin tools. This avoids the installation of numerous extensions and plugins that increase computer startup times, consume operating memory, and/or include code for redundant components. Also, installing plugin tools that include multiple functions avoids the creation and maintenance of large numbers of independent plugins that are cumbersome for a computing system to install, manage, and execute.

Also, embodiments enhance security by limiting access to certain plugin tools to particular users, roles, or teams of an organization. For example, one bundle of plugin tools for an engineering team may allow access to one set of resources, whereas another bundle of plugin tools for a legal team may allow access to a different set of resources.

Furthermore, the embodiments enhance security by maintaining a library of the plugin tools comprising a secure, trustworthy source tailored for a particular organization. As such, embodiments avoid installing plugin tools from external sources that serve as vectors for malware and data exfiltration.

Moreover, embodiments enhance security by generating plugin tools within a controlled computing system of an organization, installing the plugin tools for extensible software on a user device of the controlled computing system and executing the plugin tools locally within the memory space of the user device. This increases data security by avoiding transmission of sensitive information processed by the plugin tools outside of the application and the computing system. For example, using a plugin tool for a coding environment, a developer can send a web token to an internal website of the controlled computing system to decode. Web tokens may comprise sensitive information as either cryptographic material or user identity information. Accordingly, decoding the web token locally via an organization-specific plugin tool prevents the web token from leaving the secure computing environment of the organization.

### 3. Software Quality Assurance Environment Architecture

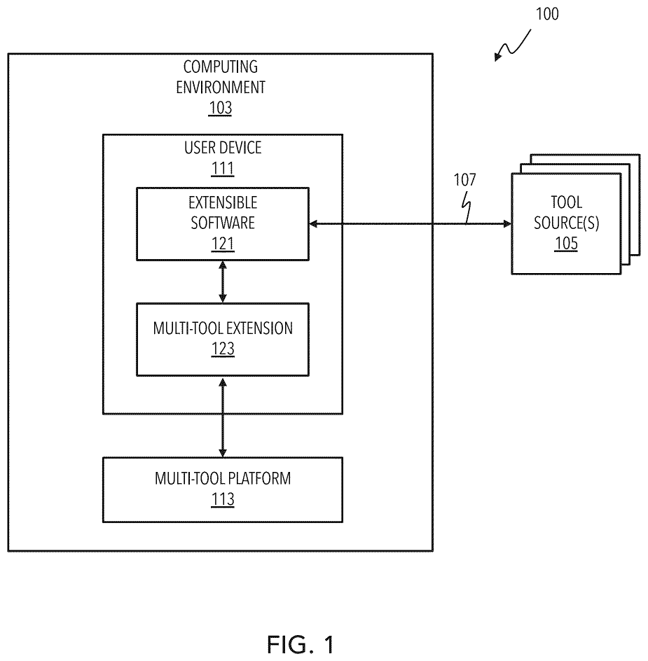

FIG. 1 shows a block diagram illustrating an example architecture 100 for implementing systems, methods, and computer program products in accordance with aspects of the present disclosure. The components of the architecture 100 may be distributed over multiple applications and/or machines. Multiple components may be combined into one application and/or machine. Operations described with respect to one component may instead be performed by another component.

The example architecture 100 includes a computing environment 103 and one or more tool sources 105 in communication via one or more communication links 107. The communication links 107 transmit data between the computing environment 103 and the tool sources 105. The communication links 107 comprise any combination of wired and/or wireless links, any combination of one or more types of networks, including the Internet, a wide-area network (WAN), a local-area network (LAN), a wireless network, a digital subscriber line (DSL) network, a frame relay network, an asynchronous transfer mode (ATM) network, and a virtual private network (VPN).

The tool sources 105 comprise software libraries that serve software plugins and extensions. The tool sources 105 are external to and independent of the computing environment 103. For example, entities operating the tool sources 105 may be entities, such as third-party providers, that have no direct operational, financial, or administrative connection to an entity operating the computing environment 103. Additionally, or alternatively, the plugins and extensions stored by tool sources 105 may be generated and published by third-party developers. As such, the tools and extensions stored by the tool sources 105 are not necessarily secure or free of malware. Thus, they represent a potential security threat if downloaded into the computing environment 103.

The computing environment 103 comprises a controlled computing environment in which users, software, services, resources, and activities are limited by predefined policies and procedures. For example, the computing environment 103 may be operated by an organization, such as a private, business, government, educational entity. The computing environment 103 restricts the interactions of its internal users, software, services, and resources with external entities, such as the tool sources 105. For example, the computing environment 103 directs traffic through firewalls and proxies that block unauthorized connections and enforce compliance with organizational policies and procedures. Accordingly, the computing environment 103 may prevent users from accessing, installing, and/or executing plugins and extensions at the tool sources 105. Additionally, the computing environment 103 enforces user authentication and role-based access control that restrict users'access to internal software, services, and resources corresponding to the users'roles and responsibilities. For example, the computing environment 103 may limit users'access to internal applications, plugin tools, and computing resources.

Embodiments of the computing environment 103 comprise a user device 111, and a multi-tool platform 113. The user device 111 may comprise a computing device, such as a desktop computer, a workstation, a remote terminal, a laptop computer, a tablet computer, a smartphone, or the like. In one or more embodiments, the user device 111 includes a computer-user interface comprising hardware and/or software configured to facilitate communications between a user and the user device 111 for interacting with software applications and environments, such as the tool sources 105 and the multi-tool platform 113.

Embodiments of the user device 111 execute extensible software 121 and a multi-tool extension 123. The extensible software 121 comprises a software system that allows users to extend its capabilities beyond the original functionality without modifying the code of the extensible software 121 itself. Examples of extensible software 121 include code editors, web browsers, productivity applications, graphic design applications, and operating systems. Extensibility enables the extensible software 121 to adapt to user requirements and preferences, integrate with other systems, and/or support additional features. Plugin tools include modular software components that add or expand the functionality of the extensible software 121 by interfacing with the multi-tool extension 123. Example plugin tools include plugins, widgets, add-ons, macros, scripts, themes, and similar modular components.

The multi-tool extension 123 comprises a software extension that is itself extensible by plugin tools. The multi-tool extension 123 provides a unified interface that accesses, installs, executes, and manages plugin tools for the extensible software 121. Some embodiments of the multi-tool extension 123 comprise a particular plugin architecture, and the plugin tools comprise modules compatible with plugin architecture. Using the multi-tool extension 123, a user may choose to install, activate, and/or delete one or more plugin tools. When activated using the multi-tool extension 123, the extensible software 121 renders the plugin tool directly within a user interface of the extensible software 121. Additionally, embodiments of the multi-tool extension 123 are persistent such that, after installation into the extensible software 121, the multi-tool extension 123 remains active and integrated within the extensible software 121 until removed or deactivated.

As detailed below, the multi-tool platform 113 comprises hardware and software that interacts with the multi-tool extension 123 for accessing, managing, and installing plugin tools from the plugin tool library 115 into extensible software 121. The multi-tool platform 113 functions as an interface through which the multi-tool extension 123 interacts with an internal library of plugin tools. The multi-tool platform 113 also generates a directory that organizes, filters, and presents the available plugin tools in a directory that allows users to browse, search, and select specific plugin-tools. The directory displays metadata of the plugin tools, such as name, description, author, source code repository, rating, installations, removals, activations, version, user roles, teams, bundles, and/or similar third-party tools. The multi-tool platform 113 generates and maintains the directory with plugin tools that are currently available to particular users. For example, the multi-tool platform 113 presents a display including plugin-tools available to specific users based on the users'attributes.

### 4. Multi-Tool Platform Architecture

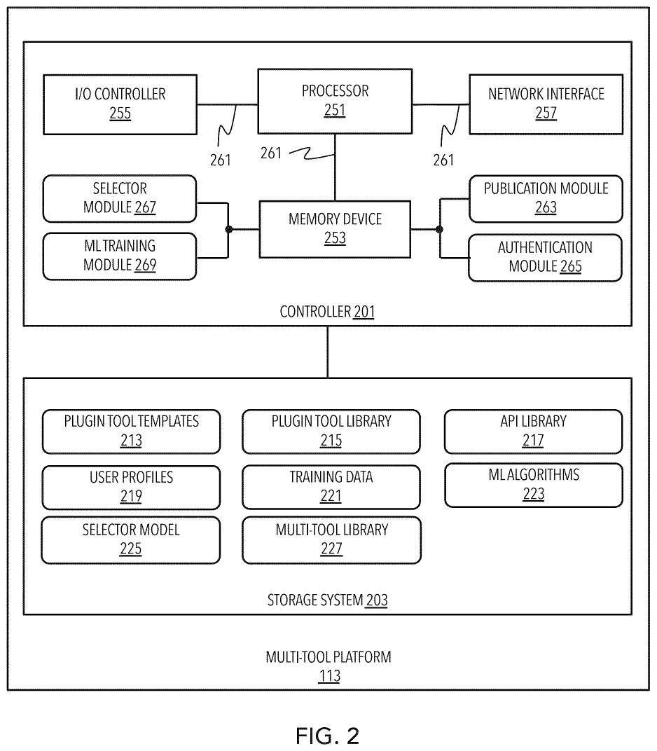

FIG. 2 illustrates a block diagram of an example computing system architecture of the multi-tool platform 113 in accordance with one or more embodiments. The multi-tool platform 113 includes hardware and software that perform processes and functions described herein. In one or more embodiments, the multi-tool platform 113 may include more or fewer components than the components illustrated in FIG. 2. The components may be local to or remote from each other. Each component may be distributed over multiple applications and/or machines. Multiple components may be combined into one application, package, and/or machine. Furthermore, operations described with respect to one component may instead be performed by another component.

The multi-tool platform 113 comprises one or more controllers, such as controller 201, and one or more hardware storage devices, such as storage system 203. In accordance with aspects of the present disclosure, the controller 201 and the storage system 203 are configured to perform specialized functions and operations, consistent with embodiments described herein. Additionally, embodiments of the multi-tool platform 113 interact with other computers (e.g., user device 111) via a network and/or I/O devices.

The storage system 203 comprises one or more computer-readable, non-volatile hardware storage devices that store information and program instructions. The storage system 203 may comprise any type of storage unit and/or device (e.g., a file system, database, collection of tables, or any other storage mechanism) for storing data. Additionally, the storage system 203 may include multiple different storage units and/or devices. The multiple different storage units and/or devices may or may not be of the same type or be located at the same physical site. Furthermore, the storage system 203 may be implemented or executed on the same computing system as the multi-tool platform 113. Additionally, or alternatively, the storage system 203 may be implemented or executed on a computing system separate from the multi-tool platform 113. For example, the storage system 203 may be communicatively coupled, wired and/or wirelessly, to the multi-tool platform 113 via a direct connection or via a network.

One or more embodiments of the storage system 203 store plugin tool templates 213, a plugin tool library 215, an API library 217, user profiles 219, training data 221, machine learning algorithms 223, a selector model 225, and a multi-tool library 227. The plugin tool templates 213 store data structures that standardize the process of creating plugin tools for multi-tool extensions. A particular plugin tool template 213 includes components, such as initialization routines, configuration files, and entry points, that allow the plugin tool to interact with a multi-tool extension for extensible software. The plugin tool template 213 establishes a framework for handling dependencies, monitoring and managing user inputs, and processing data exchanged between the plugin tool, the host software, and computing resources. For example, the plugin tool template 213 may comprise a structured framework for building extensions for an integrated development environment (IDE) or other code editor. The IDE plugin tool template may include various predefined components, such as configuration files, API hooks, and/or event listeners, that allow the plugin tool to interact with the IDE's functionality via the multi-tool extension. The template may also include services for handling user commands, modifying the IDE user interface, and/or processing code-related tasks.

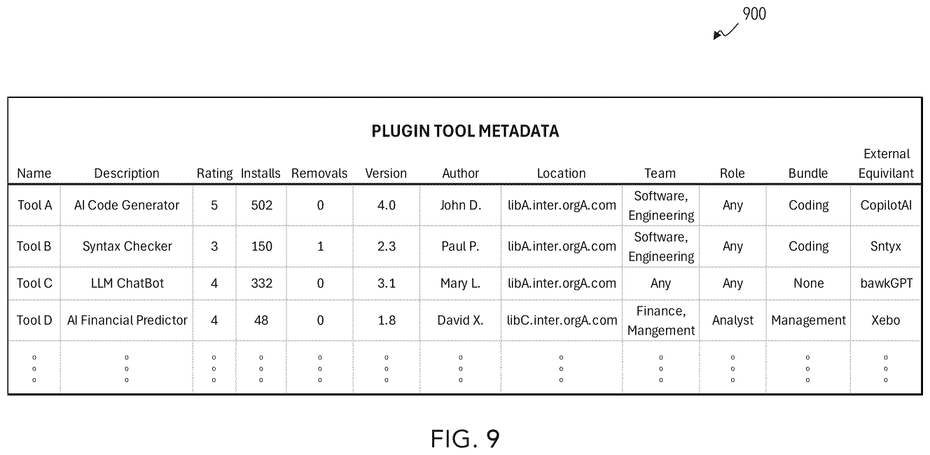

The plugin tool library 215 comprises one or more data structures storing a database that organizes and manages a collection of plugin tools for various extensible software. Embodiments of the plugin tool library 215 are internal to and/or exclusive to a particular organization or a particular computing environment. For example, the plugin tool library 215 may contain plugin tools restricted to use within the organization. Embodiments of the plugin tool library 215 maintain metadata for individual plugin tools, including descriptions, compatibilities, ratings, dependencies, and version information. For example, FIG. 9 illustrates an example data structure 900 storing metadata for plugin tools (e.g., Tool A-Tool D). The example metadata includes tool names, narrative descriptions, ratings, numbers of installations, numbers of removals, version identifiers, authors, storage locations, user roles, user teams, bundle identifiers, and substantially equivalent external plugin tools.

The API library 217 comprises one or more data structures storing APIs for interfacing plugin tools and multi-tool extensions with computing resources by defining data exchange, authentication, and request handling. An example API provides endpoints that allow a plugin tool to send and receive data, execute operations, and integrate with the functionality of an endpoint or other computing resource. For example, a financial analytics plugin tool for a spreadsheet application may use an API to retrieve real-time stock market data from an information service. The plugin tool sends a request to the API endpoint with a stock ticker symbol, and the information service responds with pricing data, trading volume, and historical trends.

The user profiles 219 comprise one or more data structures that store structured records of users within an organization, including user attributes describing users'identity, security credentials, roles, team assignments, permissions, and context information. An example user profile contains attributes describing the user, such as employee ID, department, team, role, job, authentication credentials, and/or permissions that define the level of access to the organization's computing system and resources. Additionally, the example user profile may contain attributes describing the user's activity, such as applications used, plugin tools used in the applications, and metrics describing the amount of time the user uses the application and plugin tools.

In some embodiments, the user profile includes historical context information and/or current context information. The context information may originate from various software in a computing environment, such as an operating system, a user interface, extensible software, multi-tool, and/or other software tools (e.g., a daemon), that monitor and store the user's activities. Historical context information may comprise data characterizing past user actions, behaviors, and/or patterns. Current context information may comprise data characterizing the user's current interactions with active applications, tasks and/or interactions being performed, and plugins or extensions that are currently in use. In some cases, the current context information is updated in real time or near real time, or to support recommendations of plugins relevant to the user's current context.

The training data 221 comprises one or more data structures storing training data sets for training machine learning models. Example training data sets comprise sets of employee attributes (e.g., team, role, permissions, etc.) and corresponding labels, indicating plugin tools and/or bundles of plugin tools that are appropriate for the attributes. The training data 221 may comprise structured records that represent attributes extracted from the user profiles 219. An example record of the training data 221 includes various attributes, permissions, job functions, roles, and/or teams. The labels associated with the record represent a set of plugin tools associated with a user based on the user's attributes. For example, a training dataset may include entries for a user having the role of a software developer belonging to a code development team and having a software usage history indicating access to code repositories, debugging tools, and a code development environment. The corresponding label may comprise a set of plugin tools for the code development environment. Another entry for a financial analyst may include attributes related to access controls for accounting systems and reporting tools with labels assigning a bundle of plugin tools for a spreadsheet application. By updating the training data 221 over time, embodiments allow a machine learning model to learn patterns to adapt recommendations for appropriate plugin tools for various users.

The machine learning algorithms 223 comprise one or more algorithms that are iterated to train machine learning models to map a set of input variables to an output variable. In particular, the machine learning algorithms 223 are configured to train the selector model 225 to identify a set of plugin tools for a user. A machine learning algorithm generates the selector model 225 such that the selector model 225 best fits the datasets of training data to the labels of the training data. Additionally, or alternatively, a machine learning algorithm generates the selector model 225 such that, when the selector model 225 is applied to the sets of the training data 221, a maximum number of results determined by the selector model 225 match the labels of sets of the training data 221. Different selector models 225 may be generated based on different machine learning algorithms and/or different sets of training data. The algorithms include supervised components and/or unsupervised components. Algorithms, such as linear regression, logistic regression, linear discriminant analysis, classification and regression trees, naïve Bayes, k-nearest neighbors, learning vector quantization, support vector machine, bagging and random forest, boosting, backpropagation, and/or clustering may be used.

The multi-tool library 227 comprises one or more data structures that store different versions of a multi-tool extension (e.g., multi-tool extension 123). The multi-tool library 227 catalogs versions of the multi-tool extension based on compatibility with different software applications (e.g., extensible software 121). Additionally, the multi-tool library 227 organizes extensions by version number, release date, and supported application environment, such that different versions align with the requirements of a specific software application or environment.

Still referring to FIG. 2, the controller 201 includes one or more processors 251, one or more memory devices 253, an input/output (I/O) controller 255, and a network interface 257. Additionally, the controller 201 includes at least one communication channel 261 (e.g., a data bus) by which the processor 251 communicates with the memory device 253, the input/output (I/O) controller 255, and the network interface 257. The processor 251 executes computer program instructions (e.g., an operating system, application programs, software modules, etc.) that can be stored in the memory device 253 and/or storage system 203. The processor 251 may comprise one or more general-purpose processors, special-purpose processors, and/or other programmable data processing apparatuses providing the functionality and operations detailed herein.

The memory device 253 includes a local memory operative during execution of program instructions. In some embodiments, the memory device 253 may include random access memory (RAM), read-only memory (ROM), flash memory (e.g., solid state drives (SSDs)), electrically erasable/programmable read-only memory (EEPROM), etc. In some embodiments, communication between the memory device 253, the storage system 203, and the processor 251 encompasses the processor 251 accessing the memory device 253 and/or the storage system 203, exchanging data with the memory device 253 and/or the storage system 203 (e.g., reading/writing data to the memory device 253), and/or storing data to the memory device 253 and/or the storage system 203.

The network interface 257 comprises a digital device that performs network communication with external devices. For example, the network interface 257 may connect the multi-tool platform 113 to a local area network (LAN), a wide area network (WAN), and/or the Internet. The network interface 257 may include wired and/or wireless communication hardware.

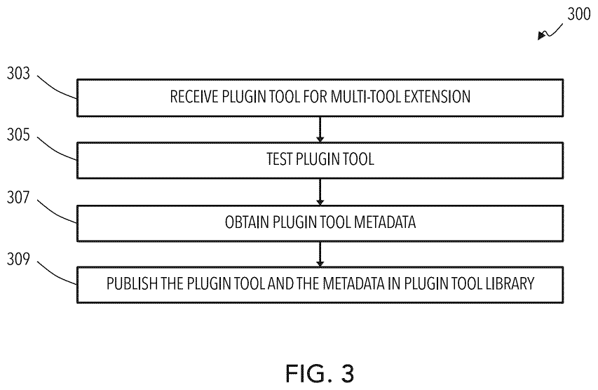

The controller 201 includes hardware and/or software configured to perform operations described herein. Example operations are described below with reference to FIGS. 3-6. The controller 201 executes computer-readable program instructions, such as an operating system and application programs, that are stored in memory devices and/or the storage system 203. Moreover, the controller 201 executes program instructions of a publication module 263, an authentication module 265, a selector module 267, and a machine learning (ML) training module 269.

The publication module 263 generates plugin tools using a plugin tool template 213 and publishes the plugin tools to the plugin tool library 215 along with metadata describing the plugin tools. Embodiments of the publication module 263 read a template, insert the input values into code sections, and produce a plugin tool file. Additionally, the publication module 263 may generate a specification file that lists functions, operations, and interactions in the plugin.

The authentication module 265 processes user authentication requests by verifying identities and managing access to applications, resources, extensions, and plugin tools based on stored credentials and security policies. For example, the authentication module 265 may authenticate a user by querying a credential store to retrieve the corresponding stored credentials associated with the username or other unique identifier. The authentication module 265 then performs a comparison between the provided password and the stored password using a hashing algorithm or other cryptographic verification method. If the credentials match, the authentication module 265 grants access. If the credentials do not match, the authentication module 265 denies access.

The selector module 267 manages the identification of a set of plugin tools from the plugin tool library 215 for presentation to a user for installation into the user's extensible software environment. For example, the selector module 267 determines plugin tools stored in the plugin tool library 215 that match the application, user identity, permissions, and/or security policies. Embodiments of the selector module 267 extract the user attributes, such as team, role, and permissions, from the user profiles 219. Based on the user attributes, the selector module 267 determines a set of plugin tools from the plugin tool library 215 appropriate for the extensible software of the multi-tool extension and the user attributes for presentation in a directory within the user interface of the extensible software. One or more embodiments of the selector module 267 apply the attributes to the selector model 225 to process the attributes and identity for the user.

The machine learning training module 269 executes machine learning algorithms 223 to train the selector model 225. The machine learning training module 269 may train the selector model 225 using user attributes in the training data 221, as well as weights or other labels of scanners applied to the specifications.

### 5. Plugin Tool Publication Process

FIG. 3 shows a flow block diagram illustrating a process 300 that includes an example set of operations for publishing plugin tools for multi-tool extensions in accordance with one or more embodiments. Embodiments publish plugin tools tailored for a controlled computing system of an organization that are solely executed within the computing system and exclusive to the organization. One or more operations of the process 300 may be modified, rearranged, or omitted. Accordingly, the particular sequence of operations illustrated in FIG. 3 should not be construed as limiting the scope of one or more embodiments.

A system receives a new or updated plugin tool generated for a multi-tool extension (Operation 303). A software developer for a particular organization may generate a plugin tool for the multi-tool extension using a template for a multi-tool extension for particular extensible software. The plugin tool may be structured according to the template for a particular software environment or application that defines entry points, event listeners, and user inputs. The plugin tool may interact with the software's core features to execute tasks, modify behaviors, add functionality, or extend existing capabilities of the software. For example, a programmer may create a plugin tool for a code development application that automates syntax corrections based on a custom grammar maintained by the organization. Using the application's core services and APIs, the plugin tool listens for code input events, analyzes syntax errors, and suggests corrections in real time.

The system tests the new or updated plugin tool (Operation 305). Testing the plugin tool includes executing a series of steps that verify the structure, functionality, and integration of the plugin tool with the host software. The verification may be performed by loading the plugin tool within a controlled environment, checking for required configuration files, and inspecting the implementation against interfaces and extension points. Additionally, the verification may run automated test cases to evaluate the plugin tool's registration of expected commands, responses to events, and/or interactions with the software's functions. Testing the plugin tool may also include verifying that the plugin tool solely communicates with endpoints within a controlled computing environment of the organization. The verification process may analyze the code of the plugin tool to identify external uniform resource locators (URLs), unauthorized API calls, or dependencies that allow communication with computing resources external to the organization. Moreover, the testing may identify outgoing requests and calls by the plugin tool attempting to communicate beyond the controlled computing environment. Furthermore, testing may include executing scans to check for vulnerabilities and other security weaknesses. The testing may further include validating compliance with rules and policies by verifying that the plugin tool follows organizational protocols and standards.

The system obtains the plugin tool metadata (Operation 307). As described above and illustrated in FIG. 9, the system maintains metadata for the plugin tool, including compatibility, ratings, dependencies, and version details. Embodiments obtain the metadata from the plugin tool's descriptions files and specifications, API responses, and user input forms, and store the data in a plugin tool library. The metadata stores the name and description of the plugin tool, user roles, teams, bundle, etc. The metadata may also include information identifying statistics of the plugin tool or previous versions of the plugin tool, such as ratings, installs, removals, and/or version identifiers. The metadata may further include information identifying the author, source, and/or location of the plugin tool. Moreover, the metadata may identify external, third-party tools that are similar to, or duplicative of, the plugin tool. For example, when processing metadata for a syntax correction plugin tool in a code development application, the system extracts the plugin tool name, description, author, and source code repository from a manifest file of the tool. The system also retrieves the organization name and user roles from authentication credentials provided during installation. The system records the plugin tool's version and tracks the number of times it is installed or removed within the organization. The system further logs activation events when the plugin tool processes syntax corrections and analyzes trends in usage.

The system publishes the plugin tool and the respective metadata (Operation 309). Embodiments store the plugin tool and its metadata in a library that organizes information in a database or repository in categories based on plugin tool attributes, usage metrics, and user associations. The system also assigns unique identifiers to each plugin tool entry and indexes metadata fields for efficient retrieval. For example, the system groups the metadata by organization, user roles, teams, bundles, and version. Additionally, the system updates records when a plugin tool is installed, activated, and/or removed, maintaining a history of interactions.

### 6. Plugin Tool Selection and Installation Process

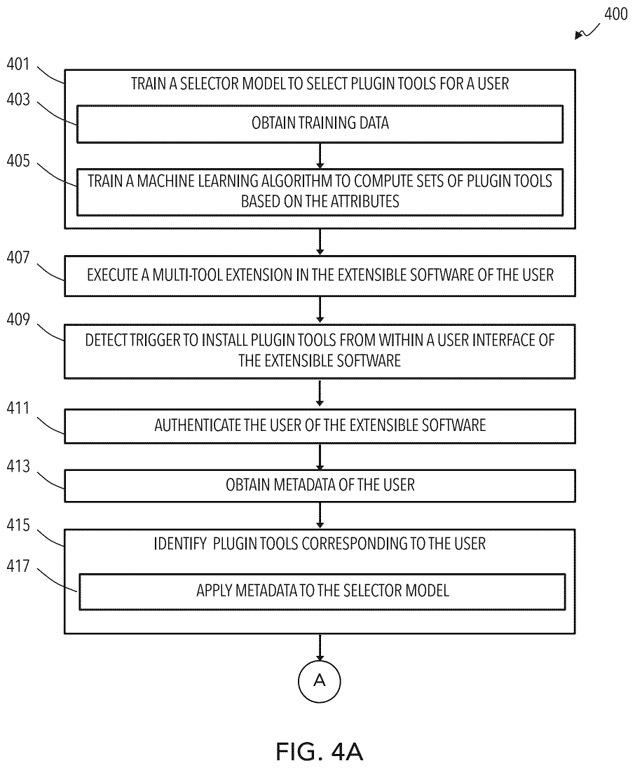

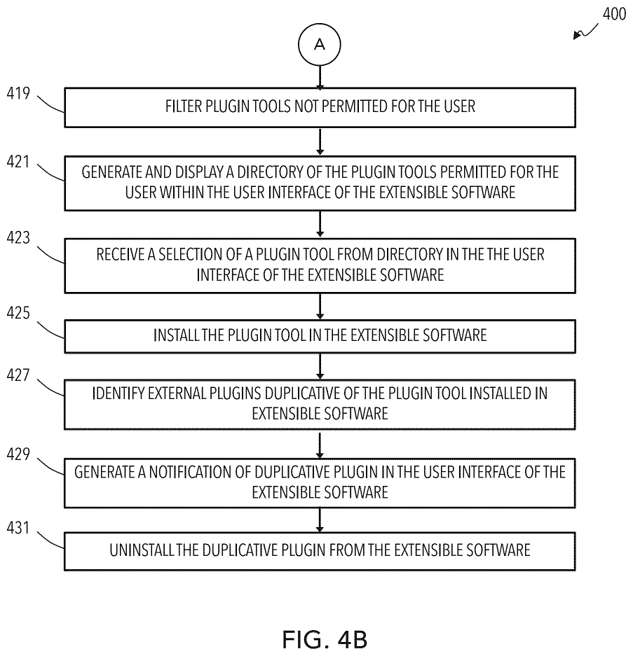

FIGS. 4A and 4B show a flow block diagram illustrating a process 400 that includes an example set of operations for selecting and installing plugin tools by the system in accordance with one or more embodiments. One or more operations of the process 400 may be modified, rearranged, or omitted. Accordingly, the particular sequence of operations illustrated in FIGS. 4A and 4B should not be construed as limiting the scope of one or more embodiments.

A system trains a selector model to select plugin tools based on user attributes (Operation 401). The selector model comprises a machine learning model that tailors plugin recommendations to individual users. The selector model may learn and adapt recommendations of plugin tools over time as the selector model discovers and suggests newly developed plugins, ensuring that users always have access to the latest and most relevant tools. The adaptability of the selector model is advantageous in environments where users work on diverse projects involving different tools. The selector model also reduces the administrative burden of curating predefined lists of plugin tools for numerous roles and teams of users. Furthermore, the selector model improves security and compliance by restricting recommendations to internal plugin tools that align with organizational policies and access controls.

In some embodiments, training the selector model includes obtaining training data (Operation 403). The training data comprises user attributes and corresponding sets of plugin tools as described above. Training the selector model also includes training a machine learning algorithm to compute sets of plugin tools based on the attributes (Operation 405). The machine learning algorithms may comprise a linear regression, logistic regression, linear discriminant analysis, classification and regression trees, naïve Bayes, k-nearest neighbors, learning vector quantization, support vector machine, bagging and random forest, boosting, backpropagation, and/or clustering algorithm. For example, a machine learning algorithm may comprise a neural learning model trained by iteratively applying input-output pairs and updating the model based on an error function. Additionally, after training the selector model, some embodiments continuously collect new labeled data and periodically retrain the model to improve the model's accuracy, correct for drift, and identify new plugin tools.

The system executes a plugin tool (e.g., multi-tool extension 123) extension in an extensible software environment or application of a user in a controlled computing environment (Operation 407). Executing the multi-tool extension loads an extension into the software's runtime environment. The multi-tool extension may be pre-installed in the extensible software by the organization, or the multi-tool extension may be accessed from within the controlled computing environment. The multi-tool extension registers with the software and integrates with the software's core processes, enabling interaction with user inputs, system events, or external services. Once installed, the multi-tool extension monitors for triggers or inputs within the software and executes tasks as required. For example, a multi-tool extension may add interactive graphic elements, such as icons, to the user interface for activating a control panel of the multi-tool extension. The extension ensures the icons are registered with the software's event handling system, and appropriate actions are triggered when the user interacts with the icons.

As previously described, embodiments of the multi-tool extension comprise a persistent extension that, after installation, remains active and integrated within the extensible software until removed or deactivated by a user. In an example code development application, a multi-tool extension is executed when the system detects that the extension is installed and enabled. The application loads the multi-tool extension during startup or when triggered by a user action. The system registers the multi-tool extension event handlers, allowing the system to monitor user input via a graphic user interface (GUI) control panel of the multi-tool extension within the software's user interface.

The system detects a trigger to install plugin tools from within a user interface of the extensible software (Operation 409). In some embodiments, the user manually triggers the multi-tool extension to present plugin tools for installation into the software without exiting the user interface of the software. The software detects the input event triggered by the user and maps it to the function responsible for launching the control panel of the multi-tool extension for activating, deleting, and installing plugin tools. For example, a programmer may interact with the user interface of a code editor application to display the control panel the multi-tool extension.

In other embodiments, one or more events in the extensible software trigger the multi-tool extension to present plugin tools for installation. The occurrence of an event may be detected by applying predefined logic, heuristics, or artificial intelligence to the user's attributes and current context information. The logic, heuristics, or artificial intelligence may be established on past user actions, behaviors, or patterns associated with the installation of plugin tools. For example, within an IDE, the system may detect context information indicating that the user opened a text editor and started modifying source code. In response to that combination of events, the system automatically triggers the multitool platform to offer plugins related to the task of editing code (e.g., syntax highlighting, code suggestions, debugging utilities an image-based code generation tool).

The system authenticates the user of the extensible software (Operation 411). The system can authenticate the user when the extensible software launches, when the multi-tool extension launches, or when the user accesses a plugin tool platform via the plugin tool to install or manage plugin tools. Embodiments verify credentials of the user based on authentication mechanisms. The user provides authentication data, such as a username, password, biometric input, or security token. The system validates the credentials against information stored by an authentication service.

The system obtains metadata of the user (Operation 413). The system may obtain the metadata from a user profile based on the user credentials obtained by the authentication operation, by user input to the GUI, and/or by verifying an existing authentication token stored by the user device, software, or multi-tool extension. The user metadata includes attributes, such as role-based access controls, team assignments, and security policies. For example, the system may obtain the user's assigned roles, teams, and access permissions in response to the successful authentication of the user by the system. In some embodiments, the user metadata also comprises historical context information and/or current context information. As previously described, historical context information may comprise past user actions, behaviors, and/or patterns. Current context information may comprise active applications, tasks being performed, interactions with a user interface of the extensible software, and/or plugins or extensions currently active in the extensible software.

The system identifies plugin tools corresponding to a user (Operation 415). The system identifies plugin tools corresponding to a user based on the user's metadata. Some embodiments, identify appropriate plugin tools by comparing the user attributes contained in the metadata with the attributes associated with the plugin tools and/or bundles of plugin tools. For example, the system may use a similarity function, such as cosine similarity or another predefined function, to score the degree of similarity between the user's attributes and the attributes of the plugin tools. Based on the similarity score, the system selects plugin tools and/or bundles that best match the user's attributes. Some embodiments of the system select the plugin tools or bundles having similarity scores exceeding a predetermined threshold. Additionally, or alternatively, the system may rank the plugin tools and/or bundles based on respective similarity scores.

Some embodiments apply the user attributes to a selector module trained to identify appropriate plugin tools for the user (Operation 417). The system transforms the set of user attributes into a feature vector compatible with the selector model and applies the feature vector to the selector model. The selector model evaluates the input and produces a recommended set of plugin tools for the user. For example, in a situation where the user is a programmer using a code development application, the selector model may process the user attributes and identify a set of programming plugin tools that include database management functions, API testing tools, and debugging extensions and refrain from identifying plugin tools related to legal, managerial, or financial roles. However, in a situation where the user's role also includes managing other programmers, the selector model may identify the set of programming tools as well as a managerial plugin tool.

Continuing to FIG. 4B, as indicated by off-page connector “A,” the system filters out plugin tools that are not permitted for the user (Operation 419). Embodiments filter out the unpermitted plugin tools based on the software and the user attributes. The system may exclude one or more of the identified plugin tools by comparing roles, access controls, and security policies associated with individual plugins to the user attributes. For example, the system compares the permissions of the plugin tools identified by the selector module with the attributes of a programmer.

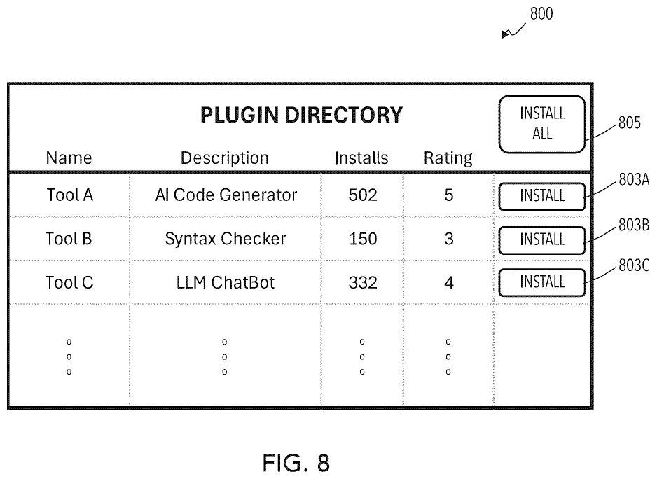

The system generates and displays a directory presenting plugin tools permitted for the user within the user interface of the extensible software (Operation 421). Some embodiments query a plugin tool library for available plugin tools and filter the results based on software compatibility, roles, access controls, and security policies. Other embodiments query the library to retrieve plugin tools identified by the selection operation. To generate the directory, the multi-tool extension retrieves metadata of the plugin tools from the plugin tool library and presents the metadata in a structured format. For example, the multi-tool extension may present the directory in the GUI control panel as a list or grid layout containing plugin tool names, descriptions, versions, authors, and usage statistics as illustrated in FIG. 8. The GUI may include options for searching, sorting, and filtering the plugin tools included in the directory. For example, in a code development application, the system queries the plugin tool library and retrieves a list of extensions designed for the application. The GUI of the application organizes the results, allowing the user to browse syntax correction tools, debugging utilities, or version control integrations. The user can select a syntax correction plugin tool to view its description, supported languages, and recent updates. The system provides an option to install, update, or remove the selected plugin tool.

The system receives a selection of a plugin tool or set of plugin tools from the directory in the GUI of the extensible software (Operation 423). The selection may include one or more plugin tools and/or one or more bundles of plugin tools. The system installs the selected plugin in the extensible software of the user (Operation 425). Embodiments download the files for the plugin tool from the plugin library and register the selected plugin tool within the multi-tool extension by updating configuration files, loading required modules, and linking the plugin tool to extension points of the multi-tool extension. For example, in a code development application, when a user selects a syntax correction plugin tool, the system retrieves the plugin tool code from its source. The system updates configuration settings to enable the syntax correction plugin tool to integrate with the components of the application. Once the installation process is complete, the application allows the user to activate the tool.

In some embodiments, the system installs the plugin tools permitted for the user without receiving individual selections of each plugin tool via the GUI. For example, the system may install all the plugin tools permitted for the user as a set comprising the plugin tools identified based on the user attributes (e.g., at operation 415) and/or those identified by the selector model (e.g., at operation 417). Additionally, or alternatively, the system may install one or more of the plugin tools permitted for the user without a user request. By doing so, embodiments predictively deliver plugin tools based on a particular user's attributes and/or current context. For instance, the system may deliver a set of additional plugin tools corresponding to a combination of plugins that are currently installed and/or active in the extensible software of the particular user. Also, the system may install new versions, upgrades, or updates to the plugin tools currently installed in the extensible software of the particular user.

The system identifies external plugin tools duplicative of plugin tools installed in the extensible environment by the user (Operation 427). The system compares metadata associated with the installed plugin tools to the metadata of the plugin tools in the bundle. The system retrieves information, such as plugin tool name, version, functionality, dependencies, and source repository, for each installed plugin tool. It then matches these attributes against the corresponding attributes of the plugin tools installed on the user device, checking for redundancy based on functionality overlap, version differences, or alternative implementations of the same functionality. The system generates a notification of the duplicative plugin tool in the extensible environment of the user (Operation 429). The notification includes information about the duplicative plugin tool, its source, and the existing version within the environment. The system delivers the notification through a user interface, a messaging service, or a logging mechanism. The system uninstalls the duplicative plugin tool from the extensible software of the user (Operation 431).

### 7. Example Embodiments

Detailed examples are described below for purposes of clarity. Components and/or operations described below should be understood as one specific example that may not be applicable to certain embodiments. Accordingly, components and/or operations described below should not be construed as limiting the scope of any of the claims.

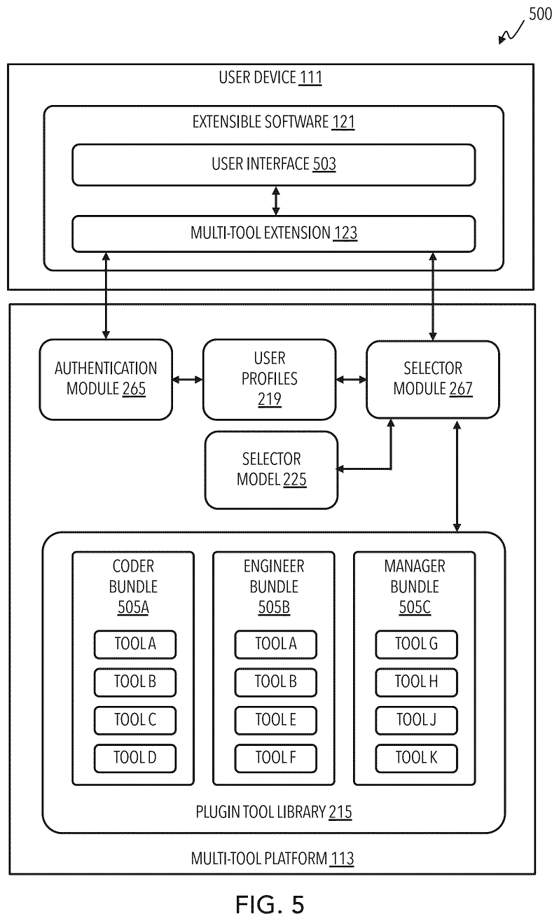

FIG. 5 illustrates a functional block diagram 500 of an example process for recommending plugin tools for a user of extensible software 121 executed by a user device 111. For the purposes of this example, the user is a programmer employed by a business organization, and the software 121 is a code development application. In accordance with the foregoing description, a multi-tool extension 123 is installed in the software 121 and interacts with a multi-tool platform 113 to access, install, execute, and manage plugin tools, such as tools A-K in the plugin tool library 215. The multi-tool extension 123 may be installed by the user or another individual, such as an information technology technician, from a library (e.g., multi-tool library 227) within the multi-tool platform 113. After installation, the multi-tool extension 123 remains active and integrated within the software 121.

In the present example, the user activates the multi-tool extension 123 via a user interface 503 of the software to install plugin tools. The multi-tool extension 123 interacts with a multi-tool platform 113 to identify plugin tools appropriate for the software 121 and the user. In the multi-tool platform 113, authentication module 265 may authenticate the user using credentials stored in association with the user profiles 219, the software 121, the user interface 503, and/or the multi-tool extension 123.

The multi-tool platform 113 recommends one or more of example plugin tools A—K for the software 121 based on attributes of the user stored in the user profiles 219. For example, the attributes may comprise some or all of the user's job, team, department, seniority level, security level, permissions, application used, and plugin tools used. Some embodiments recommend a particular bundle 505 of plugin tools based on the user's attributes. For example, as illustrated in FIG. 5, the plugin tool library 215 stores various bundles 505 corresponding to different user roles. More specifically, the bundles include a coder bundle 505A (e.g., tools A, B, C, and D), an engineer bundle 505B (e.g., tools A, B, E, and F), and a manager bundle 505C (e.g., tools G, H, J, and K). Each of the bundles 505 includes a subset of the plugin tools A-K stored in the plugin tool library 215 that are tailored to a different role in the organization.

The selector module 267 identifies one or more of the bundles 505 for recommendation to the user based on the user's attributes. As previously described, some embodiments of the selector module 267 identify the plugin tools by applying the user's attributes to a selector model 225. Using the output of the selector module 267, the multi-tool extension 123 generates and displays a directory of plugin tools recommended for the particular user, such as the example directory illustrated in FIG. 8.

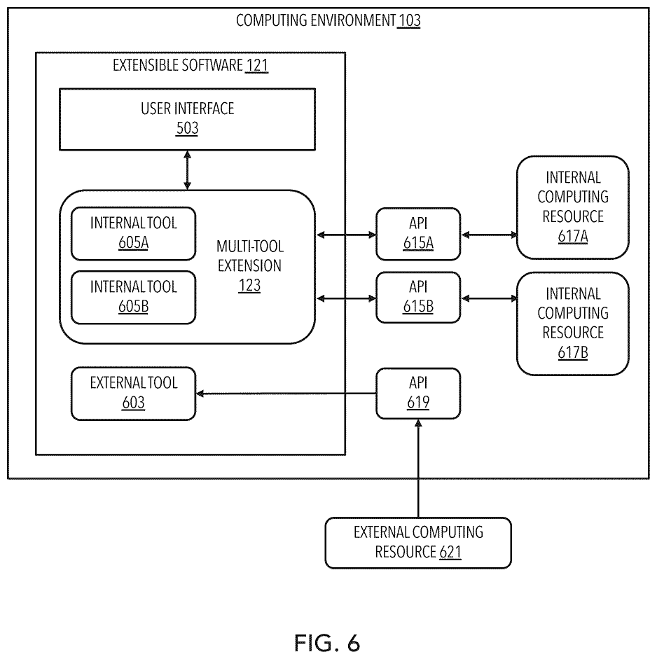

FIG. 6 illustrates a functional block diagram of an example process for executing plugin tools in a controlled computing environment 103 in accordance with one or more embodiments. In accordance with the foregoing description, a user of extensible software 121 may wish to install various plugin tools that add or extend functionality of the software 121. Some of this functionality may be provided using an external tool 603 obtained from a source outside of the computing environment 103 (e.g., plugin tool source 105). For example, the external tool 603 may be a generative AI chatbot that interacts with an external computing resource 621 operated and/or owned by an entity independent of the organization operating the computing environment 103. Other functionality may be added using internal tools 605A and 605B obtained from a source internal to the controlled computing environment 103. For example, plugin tool 605A may be a syntax checker, and tool 605B may be an AI code generator obtained from an internal library (e.g., plugin tool library 215).

The internal tools 605A and 605B may be created, stored, and executed entirely within the controlled computing environment 103. As such, the computing environment 103 trusts the internal tools 605A and 605B to access internal computing resources 617A and 617B. For example, the computing environment 103 applies access controls and security policies to permit the plugin tools 605A and 605B to access confidential or secure internal resources 617A and 617B and prevent the plugin tools 605A and 605B from accessing external computing resources, such as external resource 621. On the other hand, the computing environment 103 does not trust the external tool 603 because it was created, stored, and/or sourced externally to the controlled computing environment 103. As such, the computing environment 103 prevents the external plugin tool 603 from accessing internal computing resources 617A and 617B, while permitting the external plugin tool 603 to access the external computing resources 621.

When triggered by user requests in the user interface 503, the tools 605A and 605B invoke the computing resources 617A and 617B via the multi-tool extension 123 to process the requests and present the results through the user interface 503. For example, the tool 605A communicates the user request via the multi-tool extension 123 to an API 615A that provides a defined interface for exchanging information with the internal computing resource 617A. When returning an output of the internal computing resource 617A, the API 615A passes the output to the internal tool 605A back through the multi-tool extension 123.

For example, the plugin tool 605A may be a syntax checker that monitors the text editor for changes in the user's code. The restricted computing resource 617A may be a parser that uses an organization-specific grammar. When the user modifies a file in the text editor, the plugin tool 605A detects the update and sends the code to the parser via the multi-tool extension 123 using the internal API 615A. The parser analyzes the structure and syntax of the code according to predefined rules and returns output to the code editor. If the parser identifies errors or inconsistencies, the plugin tool 605A retrieves the results and formats them into a message. The plugin tool 605A causes the user interface 503 to display inline annotations, highlights, or entries in a diagnostics panel within the user's code.

The user may also interact with the external plugin tool 603 with the user interface 503. The external plugin tool 603 interfaces with the API 619 that provides a defined interface for the external plugin tool without using or interacting with the multi-tool extension 123 or the APIs 615 of the internal computing resources 617. The external tool 603 sends information to the external computing resource 621 via the API 619. When triggered by a user action, the external tool 603 processes the action and presents the results through the user interface 503 without using the multi-tool extension 123 and without accessing the internal computing resources 617 of the controlled computing environment 103.

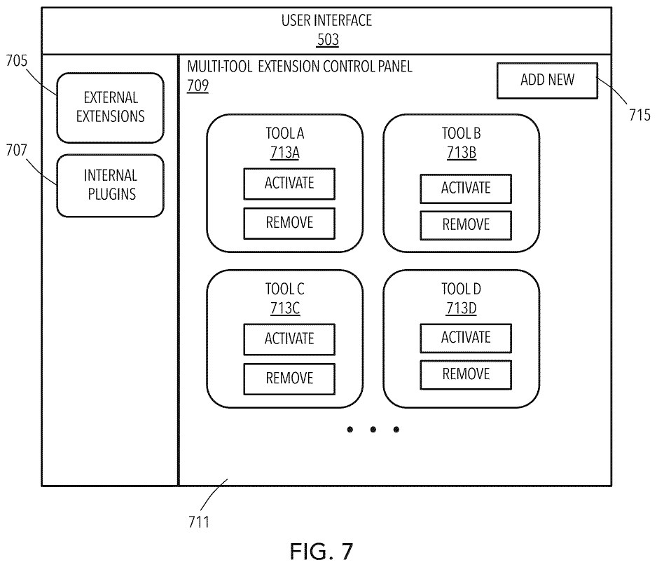

FIG. 7 illustrates an example screen of the user interface 503 for a multi-tool extension installed in an extensible software in accordance with one or more embodiments. The user interface 503 includes interactive graphic elements for accessing, installing, activating, and interacting with plugin tools to the software. The interactive graphic elements include icon 705 for external plugins and an icon 707 for triggering a control panel 709 for installing, managing, and activating internal plugin tools of a multi-tool extension. As previously described, the external plugins are obtained from and processed by sources external to a controlled computing system of an organization. The internal plugin tools may be securely obtained from an internal plugin tool library securely executed entirely within the controlled computing system of the organization.

By selecting the internal extensions icon 707, the user triggers the user interface 503 of the software to present an interactive user interface screen 711 that displays the multi-tool extension control panel 709, including a set of interactive graphic elements 713A-713D that represent plugin tools installed in the application. Each of the interactive graphic elements 713A-713D includes selectors (e.g., interactive buttons) for activating and removing the respective plugin tool. Additionally, the multi-tool extension control panel 709 displays an “add new” plugin tool icon 715 that triggers a process for adding new plugin tools from the internal library. In response to the user activating of the new plugin tool icon 715, the user interface 503 presents an interactive screen displaying a directory of plugin tools generated by the computing system. For example, FIG. 8 illustrates an example directory 800 of plugin tools displayed by the multi-tool extension control panel 709 in accordance with one or more embodiments. The directory 800 may comprise a list of plugin tools permitted for the user, as previously described. Using interactive graphical elements 803A-803C, the user may selectively install individual plugin tools. Additionally, using interactive graphical element 805, the user may install all the plugin tools permitted for the user.

### 8. Miscellaneous; Extensions

Embodiments are directed to a system with one or more devices that include a hardware processor and that are configured to perform any of the operations described herein and/or recited in any of the claims below.

In an embodiment, a non-transitory, computer-readable storage medium comprises instructions that, when executed by one or more hardware processors, cause performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A system comprising:
at least one processor; and
at least one computer-readable storage device storing program instructions;
wherein the program instructions, when executed by the at least one processor, cause the system to perform operations comprising:
executing, in a controlled computing environment, a multi-tool extension by extensible software of a user;
installing, via the extensible software using the multi-tool extension, a first plugin tool of a plurality of plugin tools from a plugin tool library of the controlled computing environment, wherein the first plugin tool is authorized to access a computing asset in the controlled computing environment;
receiving, by the first plugin tool, a request from the user for the computing asset;
calling, by the first plugin tool via the multi-tool extension, the computing asset; and
presenting information obtained from the computing asset by a user interface of the extensible software.

2. The system of claim 1, wherein calling the computing asset comprises:
generating a first call by the first plugin tool to the multi-tool extension based on the request from the user; and
generating a second call by the multi-tool extension to an API of the computing asset based on the first call.

3. The system of claim 1, wherein:
the multi-tool extension and the computing asset are solely restricted to the controlled computing environment.

4. The system of claim 3, wherein the operations further comprise:
installing a second plugin tool for the extensible software from a second plugin tool library external to the controlled computing environment; and
preventing access to the computing asset by the second plugin tool.

5. The system of claim 4, wherein the operations further comprise:
accessing a second computing asset via the second plugin tool by generating an external call to an API external to the controlled computing environment.

6. The system of claim 1, wherein installing the first plugin tool of the plurality of plugin tools comprises:
determining metadata of the user; and
identifying a set of the plugin tools in the plugin tool library associated with the extensible software of the user and the metadata of the user.

7. The system of claim 6, wherein the metadata of the user comprises one or more of:
permissions, teams, and roles.

8. The system of claim 6, wherein identifying the set of the plugin tools comprises:
applying at least some of the metadata of the user to a machine learning model trained to select a set of the plurality of plugin tools for the user.

9. The system of claim 1, wherein the extensible software comprises one of the following:
integrated development environment, a Web browser, and a software application.

10. A method comprising:
executing, in a controlled computing environment, a multi-tool extension by extensible software of a user;
installing, via the extensible software using the multi-tool extension, a first plugin tool of a plurality of plugin tools from a plugin tool library of the controlled computing environment, wherein the first plugin tool is authorized to access a computing asset in the controlled computing environment;
receiving, by the first plugin tool, a request from the user for the computing asset;
calling, by the first plugin tool via the multi-tool extension, the computing asset; and
presenting information obtained from the computing asset by a user interface of the extensible software.

11. The method of claim 10, wherein calling the computing asset comprises:
generating a first call by the first plugin tool to the multi-tool extension based on the request from the user; and
generating a second call by the multi-tool extension to an API of the computing asset based on the first call.

12. The method of claim 10, wherein:
the multi-tool extension and the computing asset are solely restricted to the controlled computing environment.

13. The method of claim 12, further comprising:
installing a second plugin tool for the extensible software from a second plugin tool library external to the controlled computing environment; and
preventing access to the computing asset by the second plugin tool.

14. The method of claim 13, further comprising:
accessing a second computing asset via the second plugin tool by generating an external call to an API external to the controlled computing environment.

15. The method of claim 10, wherein installing the first plugin tool of the plurality of plugin tools comprises:
determining metadata of the user; and
identifying a set of the plugin tools in the plugin tool library associated with the extensible software of the user and the metadata of the user.

16. The method of claim 15, wherein the metadata of the user comprises one or more of: permissions, teams, and roles.

17. The method of claim 15, wherein identifying the set of the plugin tools comprises:
applying at least some of the metadata of the user to a machine learning model trained to select a set of the plurality of plugin tools for the user.

18. The method of claim 10, wherein the extensible software comprises one of the following:
integrated development environment, a Web browser, and a software application.

19. A non-transitory computer readable medium comprising instructions that, when executed by one or more hardware processes, causes performance of operations comprising:
executing, in a controlled computing environment, a multi-tool extension by extensible software of a user;
installing, via the extensible software using the multi-tool extension, a first plugin tool of a plurality of plugin tools from a plugin tool library of the controlled computing environment, wherein the first plugin tool is authorized to access a computing asset in the controlled computing environment;
receiving, by the first plugin tool, a request from the user for the computing asset;
calling, by the first plugin tool via the multi-tool extension, the computing asset; and
presenting information obtained from the computing asset by a user interface of the extensible software.

20. The non-transitory computer readable medium of claim 19, wherein calling the computing asset comprises:
generating a first call by the first plugin tool to the multi-tool extension based on the request from the user; and
generating a second call by the multi-tool extension to an API of the computing asset based on the first call.
